(19) United States
(12) Patent Application Publication
(10) Pub. No.: US 2006/0039033 A1
(43) Pub. Date: Feb. 23, 2006

(54) Method and apparatus for providing hard-copy output from a portable memory device

(76) Inventors: William M. French, Boise, ID (US); Susan M. Janz, Eagle, ID (US); Bruce Johnson, Eagle, ID (US)

Correspondence Address: HEWLETT-PACKARD DEVELOPMENT COMPANY;Intellectual Property Administration, P.O. Box 272400, Fort Collins, CO, 80527-2400, US

(21) Appl. No.: 10/920,930

(22) Filed: Aug. 17, 2004

(51) Int. Cl. G06K 15/00

(52) U.S. Cl. 358/1.16

(57) ABSTRACT

A method and an embodiment for providing hard-copy output from a portable memory device wherein a portable memory device is recognized. One or more files stored on the portable memory device are identified and a list of the identified files is presented to a user. The user selects one or more files from the presented list. A printable image is then prepared according to a file specified by the user file selection. The printable image is the imparted onto a physical medium.

### BACKGROUND

Mobile computer users often find themselves in a situation where they need to print out a hard-copy of a document that they are working on. In order to obtain a hard-copy output of a document, the mobile computer user typically needs to interface directly with a printer. This is problematic because most printers available to a mobile computer user are integrated into a network environment. In order to attach to a network environment, the mobile computer user is typically required to alter specific network settings that govern connectivity of the mobile computer, for example a notebook computer, to a network. It should be appreciated that such connectivity may be difficult for some users to accomplish because of the technical complexity of integrating with a foreign network.

Even if the mobile computer user can successfully integrate into a foreign networking environment, there are yet other obstacles that must be overcome before a printer attached to the networking environment can be utilized. One such obstacle is that the identifying a printer attached to the networking environment. Although this may be simple for some users, other users may not be able to identifying a printer attached to a foreign networking environment. Yet another obstacle is that of installing a printer driver. Typically, a printer driver needs to be installed to enable a mobile computer to properly convey a printable image to the printer. Again, a certain level of sophistication is required to behalf of the mobile computer user in order to install a printer driver for a new printer. It should also be appreciated that a print driver may simply not be available for a particular printer attached to the foreign networking environment.

As an alternative, a mobile computer user could simply attach a printer directly to the printer port of the mobile computer. Although the mobile computer user may have a simpler task in identifying a printer in this scenario, the mobile computer user may continue to have a problem in acquiring the necessary printer driver and then installing the printer driver on the mobile computer. Although these technical hurdles may seem trivial to some technically advanced computer users, other less sophisticated computer users will simply not be able to utilize a printer in this manner. Accordingly, many mobile computer users will simply not be able to obtain a hard-copy output they need as they continue through their daily activities.

Yet another problem with identifying a printer and installing a printer driver for that printer is that of computer clutter. In other words, every time that a user needs to install a new printer driver, more and more printer drivers will accumulate in the mobile computer. Typically, the mobile computer will provide to a user a list of all available printers that can be used to print a document. This may not immediately appear to be a grave problem. However, as more and more printer drivers are installed on a mobile computer, user frustration will result because a print command issued by the user will result in a plethora of printer choices. In this situation, a user will invariably direct output to an unavailable printer.

In yet another user scenario, a computer user may not want to carry a notebook computer along. For example, a mobile computer user may only want to carry a portable memory device. In this situation, a user may want to obtain a hard-copy output of a file stored on the portable memory device.

### SUMMARY

A method and an embodiment for providing hard-copy output from a portable memory device wherein a portable memory device is recognized. One or more files stored on the portable memory device are identified and a list of the identified files is presented to a user. The user selects one or more files from the presented list. A printable image is then prepared according to a file specified by the user file selection. The printable image is the imparted onto a physical medium.

### BRIEF DESCRIPTION OF THE DRAWINGS

Several alternative embodiments will hereinafter be described in conjunction with the appended drawings and figures, wherein like numerals denote like elements, and in which:

FIG. 1 is a flow diagram that depicts one example embodiment of a method for providing hard-copy from a portable memory device;

FIG. 2 is a flow diagram that depicts one in example embodiment of a method for recognizing to portable memory device attached to a USB interface;

FIG. 3 is a flow diagram that depicts one example embodiment of a method for recognizing a portable memory device attached by means of a memory slot;

FIG. 4 is a flow diagram that it's one example embodiment of a method for presenting a list of identified files to user;

FIG. 5 is a flow diagram that depicts alternative example embodiments of methods for receiving a user file selection;

FIG. 6 is a flow diagram that it's one example alternative embodiment for preparing a printable image according to user file selection;

FIG. 7 is a flow diagram that depicts alternative embodiments of methods for launching a file viewer application;

FIG. 8 is a flow diagram that depicts yet another alternative embodiment of a method for preparing a printable image;

FIG. 9 is a block diagram of one example embodiment of a device for providing hard-copy output from a portable memory device; and

FIG. 10 is a data flow diagram that depicts the internal operation of various alternative embodiments of a device for providing hard-copy output from a portable memory device.

### DETAILED DESCRIPTION

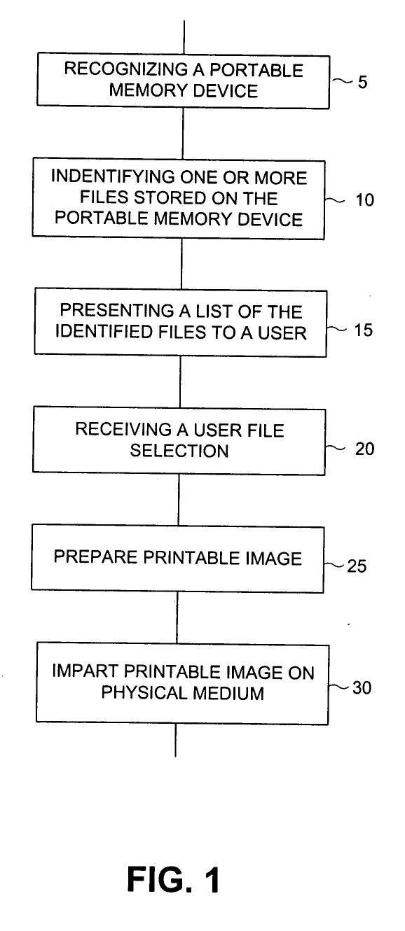

FIG. 1 is a flow diagram that depicts one example embodiment of a method for providing hard-copy from a portable memory device. According to this example embodiment, a portable memory device is recognized (step 5). One or more files stored on the portable memory device are identified (step 10). A list of the files stored on the portable memory device is then presented to a user (step 15). A user file selection is received (step 20). A printable image is then prepared from a file, when the file is determined according to the user file selection (step 25). The printable image is then imparted onto a physical medium (step 30). Typically, a portable memory device includes a solid-state memory device. Examples of such solid-state memory devices include thumb drives. Various types of interfaces can be used to interface to the portable memory device. For example, a universal serial bus (USB) can be used communicatively associate with a portable memory device. A thumb drive, as already introduced, is one example of a small portable memory device that typically uses a USB interface as a means of associating itself with a computer. A memory slot can also be used to communicatively associate with a portable memory device. A portable memory device can also include a portable disk drive. A portable disk drive can be communicatively associated through various types of interfaces, including but not limited to a USB interface and a small computer systems interface (SCSI). These are merely examples of interfaces that can be used to communicatively associate with a portable memory device and are not intended to limit the scope of the claims appended hereto. According to one illustrative use case, a mobile computer user, including a person who use their mobile computer for a business application can now use the present method to obtain a printout of a file by saving the file on a portable memory device. The present method is then used to print out a hard-copy output of the file saved on the portable memory device.

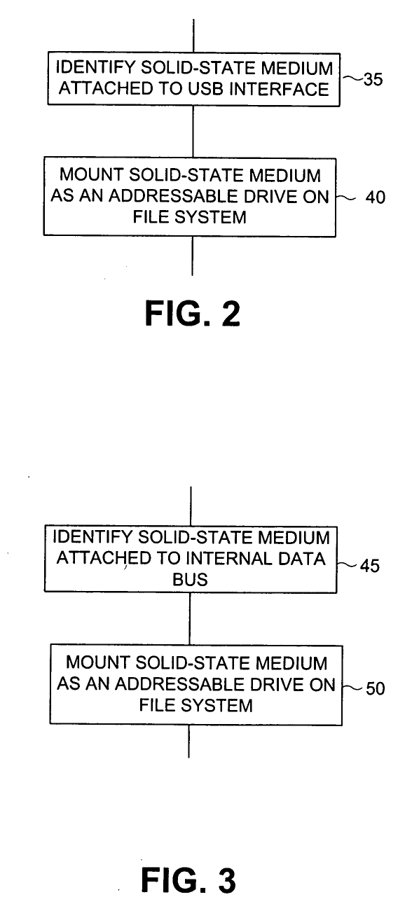

FIG. 2 is a flow diagram that depicts one in example embodiment of a method for recognizing to portable memory device attached to a USB interface. According to this example embodiment, a solid-state medium attached to a USB interface is identified (step 35). Once identified, the solid-state medium is mounted as an addressable drive on a file system (step 40).

FIG. 3 is a flow diagram that depicts one example embodiment of a method for recognizing a portable memory device attached by means of a memory slot. According to this example embodiment, a solid-state medium attached to an internal data bus is identified (step 45). Once identified, the solid-state medium is then mounted as an addressable drive on a file system (step 50).

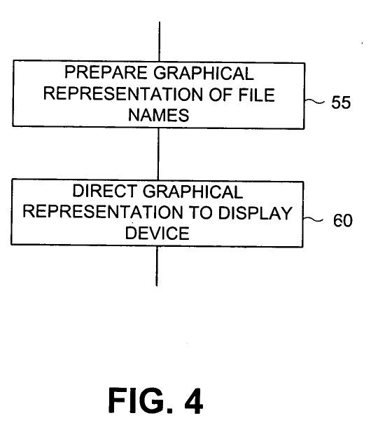

FIG. 4 is a flow diagram that it's one example embodiment of a method for presenting a list of identified files to user. According to this example embodiment, a graphical representation of file names is prepared (step 55). Typically, once a portable memory device is mounted onto a file system, the file system is able to determine a list of files stored on the portable memory device. Many modern operating systems support a graphical user interface. In such an operating system environment, the graphical user interface included in the operating system provides support for enumerating a list of files stored on a drive. It should be appreciated that an operating system can support a hierarchical file structure wherein files can be grouped together in a folder. Accordingly, one alternative embodiment of this method provides for generating a graphical representation of file names in a hierarchical fashion. Once a graphical representation of file names is generated, is directed to a display device (step 60). Once directed to the display device, a human user can then select one of the files represented in the list.

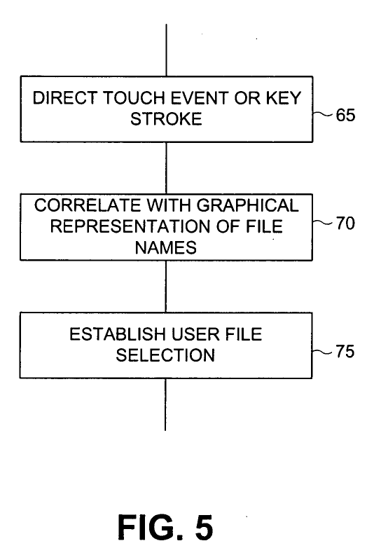

FIG. 5 is a flow diagram that depicts alternative example embodiments of methods for receiving a user file selection. According to one alternative embodiment, a touch event is detected (step 65). In yet another alternative embodiment, a keystroke is detected (step 65). Accordingly, where a touch event is detected, the touch event is correlated with a graphical representation of one or more filenames presented on a display device (step 70). In the alternative, a keystroke is detected and correlated with a graphical representation of one or more filenames presented on a display device (step 70). A user file selection (step 75) is then established according to at least one of a keystroke event and touch event, each of which is correlated with a graphical representation of one or more filenames presented on a display device.

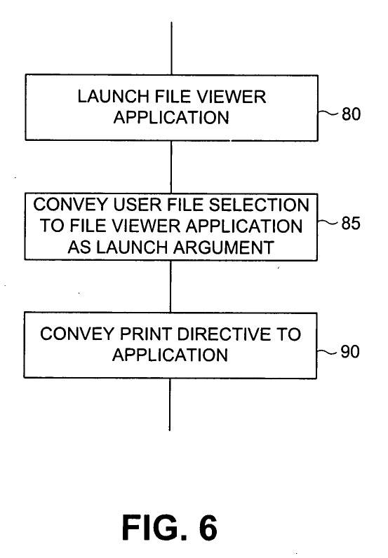

FIG. 6 is a flow diagram that it's one example alternative embodiment for preparing a printable image according to user file selection. According to this example embodiment, a file viewer application is launched (step 80). The user file selection is then conveyed (step 85) to the file viewer application. According to yet another alternative embodiment, this is accomplished by conveying the user file selection to the file viewer application as a launch argument. A print directive is then conveyed to the file viewer application (step 90). According to one alternative embodiment of this method, this is accomplished by including a print command in a launch argument conveyed to the file viewer application when it is launched.

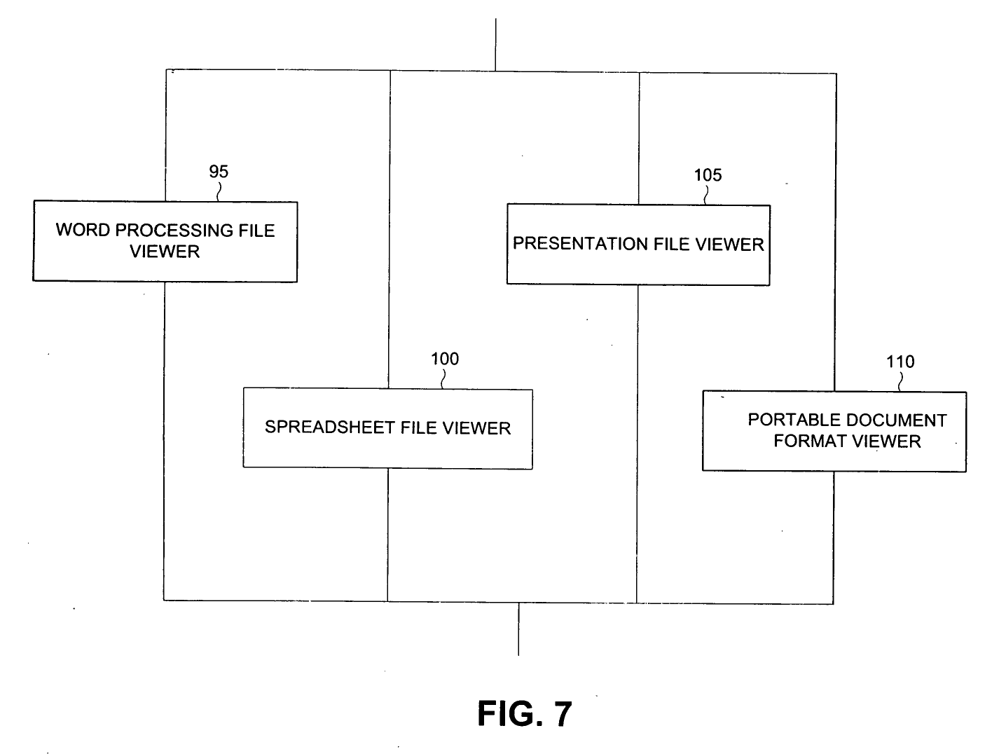

FIG. 7 is a flow diagram that depicts alternative embodiments of methods for launching a file viewer application. According to one alternative embodiment, the present method launches a word processing file viewer (step 95). According to yet another alternative embodiment, the present method launches a spreadsheet file viewer (step 100). In yet another alternative embodiment, the present method launches a presentation file viewer (step 105). And yet another alternative embodiment, the present method launches a portable document format (PDF) file viewer (step 110). It should be noted that “PDF” refers to the portable document format promulgated by the Adobe Co. and is used to referred to PDF files that conform to various versions of the PDF file specification promulgated by the Adobe Co.

According to one alternative embodiment, the type of file viewer application that is launched depends upon the type of file selected by a user. The type of file selected by a user, according to one alternative embodiment, is determined according to a file extension appended to the name of a file. Consider one alternative embodiment where the file viewer application comprises a Microsoft Word file viewer, which is one example of a word processing file viewer application. In this alternative embodiment, the Microsoft Word file viewer would be launched when the name of a file selected by a user includes the file extension “.doc”. A Microsoft Excel file viewer, which is one example embodiment of a spreadsheet file viewer, would be launched when the name of the file selected by a user includes a “.xls” file extension. Likewise, in an alternative embodiment, a Microsoft PowerPoint file viewer would be launched when the name of a file selected by a user includes a “.ppt” file extension. Microsoft Power Point is one example of a presentation file viewer application. And in yet another alternative embodiment, and Adobe Acrobat file viewer would be launched when the name of a file selected by a user includes a “pdf” file extension. Adobe Acrobat is product specifically tailored to open Adobe Acrobat portable document format files. It should be appreciated that all the affirmation of file viewer applications promulgated either by Microsoft or Adobe are intended to serve as illustrative examples of file viewer applications and are not intended to limit the scope of the claims appended hereto.

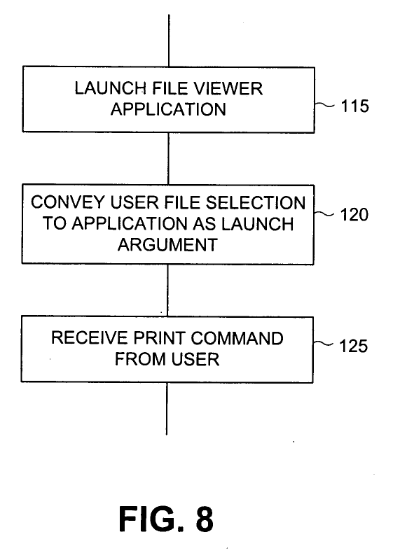

FIG. 8 is a flow diagram that depicts yet another alternative embodiment of a method for preparing a printable image. According to this alternative embodiment, a printable image is prepared by launching a file viewer application (step 115). A user file selection is conveyed to the file viewer application as a launch argument (step 120). The file viewer application is then allowed to open the file specified in the launch argument. The file your application typically presents to a user a graphical representation of the contents of the file. A print command can then be received directly from the user (step 125). In response to the print command, the file viewer application will prepare printable image and directed printable image to a print engine (e.g. a printer integrated into a device for providing hard-copy output from a portable memory device).

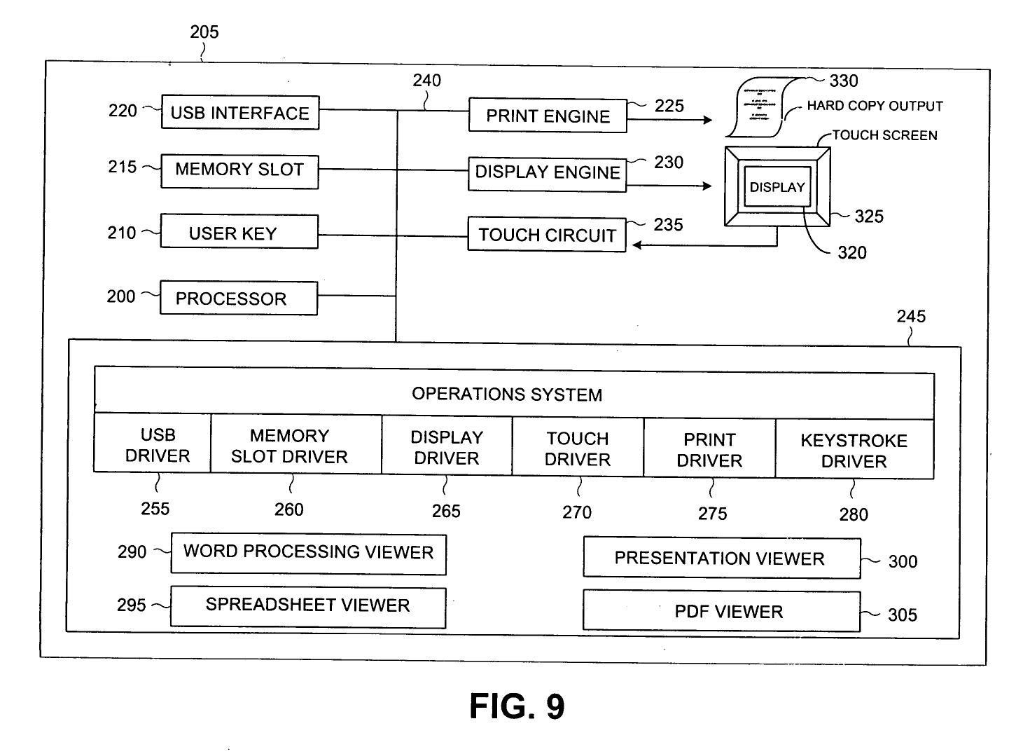

FIG. 9 is a block diagram of one example embodiment of a device for providing hard-copy output from a portable memory device. According to this example embodiment, a device 205 for providing hard-copy output from a portable memory device comprises one or more processors 200, a print engine 225, a display engine 230, a display 320, a user entry device, a portable memory device interface and a memory 245. According to one alternative embodiment, the user entry device comprises a touch screen 325 controlled by a touch circuit 235. According to yet another alternative embodiment, the user entry device comprises a user key 210. According to yet another alternative embodiment, the portable memory device interface comprises a USB interface 220. In yet another alternative embodiment, the portable memory device interface comprises a memory slot 215. All of the aforementioned components are communicatively coupled with each other by means of an internal data bus 240. It should be noted that the print engine 225, according to one alternative illustrative embodiment, comprises a laser printer. According yet another alternative illustrative embodiment, the print engine 225 comprises an inkjet printer. It should be appreciated that these are merely examples of various types of print engines and portable memory device interfaces that can be included in the present device and the scope of the claims appended hereto is not intended to be limited by any of these examples.

According to this example embodiment, a device for providing hard-copy output from a portable memory device further comprises one or more functional modules stored in the memory 245. Functional modules as described herein are referred to by a functional name. A functional module comprises an instruction sequence that is executed by one or more processors 200. As the processor 200 executes a particular instruction sequence, it performs certain functions commensurate with the teachings of the present method. The reader is advised that the term “minimally causes the processor” and variants thereof is intended to serve as an open-ended enumeration of functions performed by the processor 200 as it executes a particular functional module (i.e. instruction sequence). As such, an embodiment where a particular functional module causes the processor 200 to perform functions in addition to those defined in the appended claims is to be included in the scope of the claims appended hereto.

Stored in the memory 245 or one or more functional modules including an operating system 250. According to various illustrative alternative embodiments, the operating system 250 includes at least one of a USB driver 255, a memory slot driver 260, a display driver 265, a touch driver 270, a print driver 275 and a keystroke driver 280. Also included in the memory 245 is a file viewer application. According to various alternative embodiments, the file viewer application includes, but is not limited to at least one of a word processing viewer 290, a spreadsheet viewer 295, a presentation viewer 300 and a PDF viewer 305.

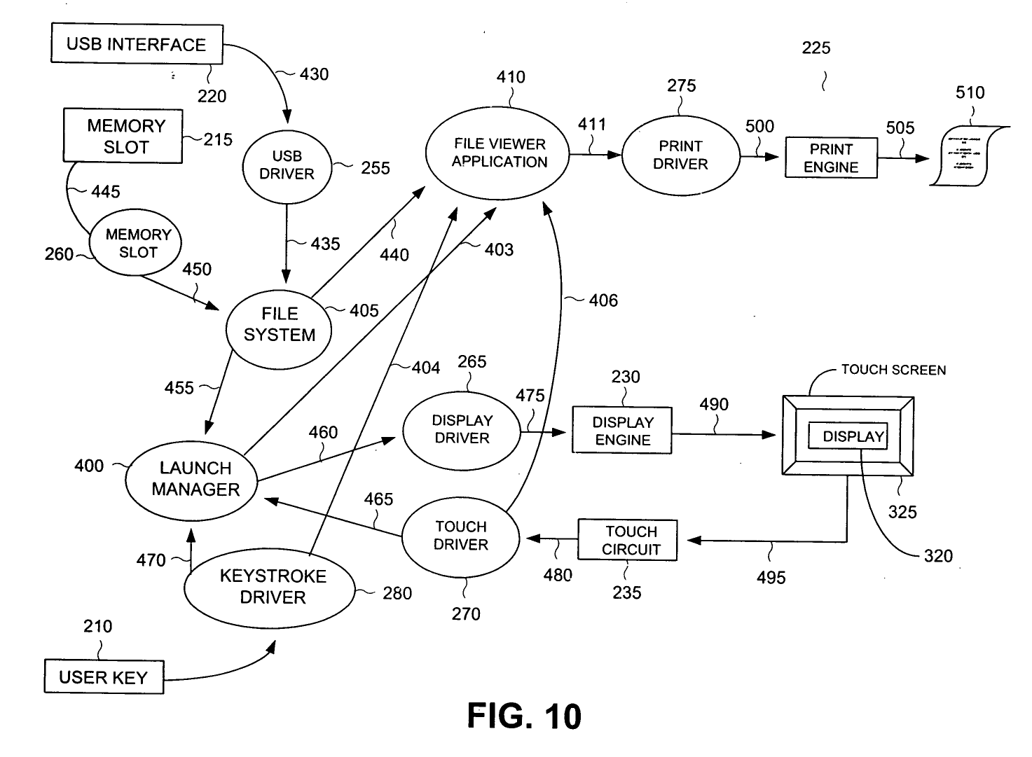

FIG. 10 is a data flow diagram that depicts the internal operation of various alternative embodiments of a device for providing hard-copy output from a portable memory device. According to one example embodiment, the processor 200 executes an operating system 250. The operating system 250, when executed by the processor 200, minimally causes the processor 200 to recognize a portable memory device that is communicatively coupled to the portable memory device interface. According to one alternative embodiment, the portable memory device interface comprises a USB interface 220. In this alternative embodiment, the processor 200 executes a USB driver 255. When executed by the processor 200, the USB driver 255 minimally causes the processor to retrieve 430 a list of one or more files stored on a portable memory device communicatively coupled to the USB interface 220. The USB driver 255, when executed by the processor 200, further minimally causes the processor 200 to direct 435 the list of one or more files to a file system module 405 included in the operating system 250. It should be appreciated that the USB driver 255, when executed by the processor 200, further minimally enables the processor 200 to mount a portable memory device (e.g. a solid-state medium) communicatively coupled to the USB interface as a disk in a file structure managed by the processor 200 as it executes the file system module 405. In yet another alternative embodiment, the portable memory device interface comprises a memory slot 215. In this alternative embodiment, the processor 200 executes the memory slot driver 260. When executed by the processor 200, the memory slot driver 260 minimally causes the processor to retrieve 445 a list of one or more files stored on a portable memory device communicatively coupled to the memory slot 215. The memory slot driver 260, when executed by the processor 200, further minimally causes the processor 200 to direct 450 the list of one or more files to the file system 405. It should be appreciated that the memory slot driver 260, when executed by the processor 200, further minimally enables the processor 200 to mount a portable memory device (e.g. a solid-state medium) communicatively coupled to the memory slot 215 as a disk in a file structure managed by the processor 200 as it executes the file system module 405.

The file system module 405, when executed by the processor 200, further minimally causes the processor 200 to provide 455 the list of one or more files to a launch manager module 400 included in the operating system 250. The launch manager module 400, when executed by the processor 200, minimally causes the processor 200 to direct the list of identified files to the display device 320. According to one alternative embodiment, this is accomplished when the launch manager module 400 prepares a graphical image reflecting the one or more files stored on a portable memory device. The launch manager module 400, when executed by the processor 200, further minimally causes the processor 200 to direct 460 to graphical image to the display driver 265. The display driver 265, when executed by the processor 200, minimally causes the processor 200 to convey 475 graphical commands to the display engine 230. In response, the display engine 230 interprets the graphical commands and generates a display signal 490 according thereto. The display signal 490 is then directed to the display 320.

The operating system 250, when executed by the processor 200, further minimally causes the processor to receive a user file selection from the user entry device. Once a user file selection is received, the operating system 250 further minimally causes the processor 200 to launch a file viewer application 410. The file viewer application 410, when executed by the processor 200, minimally causes the processor 200 to open a file stored on the portable memory device according to the user file selection, prepare printable image according to the opened file and to direct the printable image to the print engine 225. The file viewer application 410, according to one alternative example embodiment, comprises at least one of the word processing file viewer application, a spreadsheet file viewer application, a presentation file viewer application and a portable document file viewer application. It should be further appreciated that the processor 200, as it executes the operating system 250, will launch a particular file viewer application according to the type of file selected by a user by means of a user file selection. It should be further appreciated that the processor 200, as it executes another alternative embodiment of the offerings to 250, will select a particular file viewer application according to a file name extension commensurate with the techniques and teachings presented herein.

According to one alternative embodiment, the user entry device comprises a touch screen 325. In this alternative embodiment, the touch screen 325 sends impulses 495 to a touch circuit 235. The operating system 250 causes the processor 200 to receive a user file selection by minimally causes the processor 200 to execute a touch driver 270. When executed by the processor 200, the touch driver 270 receives a touch report 480 from the touch circuit 235. The processor 200, as it continues to execute the touch driver 270, conveys 465 a touch report to the launch manager 400. The launch manager 400 further minimally causes the processor 200 to correlate the touch report 465 with a graphical representation of one or more filenames presented on the display 320.

According to yet another alternative embodiment, the user entry device comprises a user key 210. One or more user keys 210 may be provided. In this alternative embodiment, the status of a user key 210 is detected by the processor 200 as it executes the keystroke driver 280. The keystroke driver 280, when executed by the processor 200, further minimally causes the processor 200 to provide a keystroke message 470 to the launch manager module 400. When executed by the processor 200, the launch manager module 400 further minimally causes the processor 200 to receive the keystroke message 470 and to selectively highlight a filename included in a graphical representation of one or more filenames generated by the processor 200 as it continues to execute the launch manager module 400. Variations in the graphical representation of one or more filenames that include the selective highlight of a filename are directed to the display driver 265 resulting in the presentation of an image on the display 320 that reflects a highlighted filename selection. For example, the user message 470 may represent a navigation keystroke that results in scrolling the highlight through a list of filenames included in the graphical representation generated by the processor 200 as it executes the launch manager module 400. In order to select a file, a “select” user keystroke 470 is received by the launch manager module 400 as an indication of the user file selection. The launch manager module 400 further minimally causes the processor 200 to correlate the select user keystroke with a highlighted filename included in the graphical representation generated by the processor 200 as it continues to execute the launch manager module 400.

The operating system 250 further minimally causes the processor 200 to launch the file viewer application 410. The operating system 250 of yet another alternative embodiment further minimally causes the processor 200 to direct 403 a user file selection to the file viewer application 410 as a launch argument. The operating system 250 of this alternative embodiment further minimally causes the processor 200 to direct 403 a print file command to the file your application 410 as a launch argument. As a result, the file viewer application 410, when executed by the processor 400, minimally causes the processor to retrieve the file from a portable memory device communicatively coupled to the portable memory device interface and generates a printable image according to the retrieved file. The printable image is then directed to the print engine 225. According to one alternative embodiment, the processor 200 executes the print driver 275 that minimally enables the processor 200 to receive the portable image 411 and to convert the printable image 411 into print directives 500 to be used to drive the print engine 225. The print engine 225 generates 505 hard-copy output 510 onto a physical medium according to the print directives 500.

According to one alternative embodiment, the operating system 250 minimally causes the processor 200 to direct 403 a user file selection to the file viewer application 410 as a launch argument. As result, the processor 200 executes the file viewer application 410 which minimally causes the processor 200 to open a file according to user file selection. The file viewer application 410 further minimally causes the processor to display the contents of the file to a user on the display 320. It should be appreciated that this is accomplished by allowing the processor 200 to interact with the display driver 265 as it continues to execute the file viewer application 410. A user can then enter a print command using at least one of the touch screen 325 and the user key 210. As such, the print command is directed (404, 406) to the file viewer application from either the keystroke driver 280 or the touch driver 270.

The functional processes (and their corresponding instruction sequences) described thus far enable providing a hard-copy output from a portable memory device in accordance with the teachings of the present method. According to one embodiment, these functional processes are imparted onto computer readable medium. Examples of such medium include, but are not limited to, random access memory, read-only memory (ROM), Compact Disk (CD ROM), Digital Versatile Disks (DVD), floppy disks, and magnetic tape. This computer readable medium, which alone or in combination can constitute a stand-alone product, can be used to convert a general-purpose computing platform working in concert with a printer into a device capable of providing hard-copy output from a portable memory device according to the techniques and teachings presented herein. Accordingly, the claims appended hereto are to include such computer readable medium imparted with such instruction sequences that enable execution of the present method and all of the teachings afore described.

While this disclosure has described several alternative methods and exemplary embodiments, it is contemplated that alternatives, modifications, permutations, and equivalents thereof will become apparent to those skilled in the art upon a reading of the specification and study of the drawings. It is therefore intended that the true spirit and scope of the appended claims include all such alternatives, modifications, permutations, and equivalents.

What is claimed is:

1. A method for providing hard-copy output from a portable memory device:
recognizing the portable memory device;
identifying one or more files stored on the portable memory device;
presenting a list of the identified files to a user;
receiving a user file selection according to the presented list;
preparing a printable image according to the user file selection; and
imparting the printable image on to a physical medium.

2. The method of claim 1 wherein recognizing a portable memory device comprises:
identifying a solid-state medium attached to a universal serial bus interface; and
mounting the solid-state medium as an addressable drive in a file system.

3. The method of claim 1 wherein recognizing a portable memory device comprises:
identifying a solid-state medium attached to an internal data bus; and
mounting the solid-state medium as an addressable drive in a file system.

4. The method of claim 1 wherein presenting a list of the identified files comprises:
preparing a graphical representation of file names; and
directing the graphical representation of file names to a display device.

5. The method of claim 1 wherein receiving a user file selection comprises:
detecting a touch event on a display device;
correlating the touch event with a graphical representation of one or more file names presented on the display device; and
establishing a user file selection according to the correlation.

6. The method of claim 1 wherein receiving a user file selection comprises:
detecting a key stroke;
correlating the key stroke with a graphical representation of one or more file names presented on the display device; and
establishing a user file selection according to the correlation.

7. The method of claim 1 wherein preparing a printable image comprises:
launching a file viewer application;
conveying to the file viewer application a launch argument according to a user file selection; and
conveying a print directive to the file viewer application.

8. The method of claim 7 wherein launching a file viewer application comprises at least one of launching a word processing file viewer application, launching a spreadsheet file viewer application, launching a presentation file viewer application and launching a portable document format file viewer application.

9. The method of claim 1 wherein preparing a printable image comprises:
launching a file viewer application;
conveying to the file viewer application a launch argument according to a user file selection; and
receiving a print command from a user.

10. A hard-copy output device comprising:
one or more processors capable of executing an instruction sequence;
print engine capable of imparting an image onto a physical medium according to a printable image;
display engine capable of displaying information to a user;
user entry device capable of receiving a user file selection;
portable memory device interface capable of providing a communicative connection from the processor to a portable memory device;
memory capable of storing one or more instruction sequences; and
instruction sequences stored in the memory including:
operating system that, when executed by the processor, minimally causes the processor to:
recognize a portable memory device communicatively coupled to the portable memory device interface;
identify one or more files stored on the portable memory device;
direct a list of identified files to the display device;
receive a user file selection from the user entry device; and
launch a file viewer application according to the user file selection; and
file viewer application that, when executed by the processor, minimally causes the processor to:
open a file stored on the portable memory device according to a received user file selection;
prepare a printable image according to the opened file; and
direct the printable image to the print engine.

11. The hard-copy output device of claim 10 wherein the portable memory device interface comprises a universal serial bus interface and wherein the operating system further comprises a universal serial bus interface driver and wherein the operating system causes the processor to recognize a portable memory device by causing the processor to execute the universal serial bus interface driver that, when executed by the processor, minimally causes the processor to mount as a disk in a file structure a solid-state medium communicatively coupled to the universal serial bus interface.

12. The hard-copy output device of claim 10 wherein the portable memory device interface comprises a memory slot interface and wherein the operating system further comprises a memory slot interface driver and wherein the operating system causes the processor to recognize a portable memory device by causing the processor to execute the memory slot driver that, when executed by the processor, minimally causes the processor to mount as a disk in a file structure a solid-state medium communicatively coupled to the memory slot interface.

13. The hard-copy output device of claim 10 wherein the operating system causes the processor to present a list of identified files by minimally causing the processor to create a graphical image reflecting one or more files stored on a portable memory device communicatively attached to the portable memory device interface and wherein the operating system includes a display driver that, when executed by the processor, minimally causes the processor to convey the graphical image to the display engine.

14. The hard-copy output device of claim 10 wherein the user entry device comprises a touch screen and the operating system includes a touch screen driver and wherein the operating system causes the processor to receive a user file selection by minimally causing the processor to execute the touch screen driver that, when executed by the processor, minimally causes the processor to receive a touch event from the touch screen and to establish a user file selection by correlating the touch event with a graphical representation of one or more files names presented on the display device.

15. The hard-copy output device of claim 10 wherein the user entry device comprises a user key and the operating system includes a keystroke driver and wherein the operating system causes the processor to receive a user file selection by minimally causing the processor to execute the keystroke driver that, when executed by the processor, minimally causes the processor to receive a keystroke event from the user key and to establish a user file selection by correlating the keystroke event with a graphical representation of one or more files names presented on the display device.

16. The hard-copy output device of claim 10 wherein the operating system causes the processor to:
direct a user file selection to the file viewer application as a launch argument so as to cause the file viewer application to open a file according to the launch argument; and
direct to the file viewer application a print directive.

17. The hard-copy output device of claim 16 wherein the file viewer application comprises at least one of a word processing file viewer application, a spreadsheet file viewer application, a presentation file viewing application, and a portable document file viewer application.

18. The hard-copy output device of claim 10 wherein the operating system causes the processor to:
direct a user file selection to the file viewer application as a launch argument so as to cause the file viewer application to open and display to a user a file according to the launch argument; and
receive a print directive from a user.

19. A computer readable medium having imparted thereon one or more instruction sequence for providing a hard-copy output from a portable memory device including:
operating system that, when executed by a processor, minimally causes the processor to:
recognize a portable memory device;
identify one or more files stored on the portable memory device;
direct a list of identified files to a display device; and
receive a user file selection from a user entry device; and
file viewer application that, when execute by the processor, minimally causes the processor to:
open a file stored on a portable memory device according to the user file selection;
prepare a printable image according to the opened file; and
direct the printable image to a printer.

20. The computer readable medium of claim 19 wherein the portable memory device is accessible through a universal serial bus and wherein the operating system further comprises a universal serial bus interface driver and wherein the operating system causes the processor to recognize a portable memory device by causing the processor to execute the universal serial bus interface driver that, when executed by the processor, minimally causes the processor to mount as a disk in a file structure a solid-state medium communicatively coupled to the universal serial bus interface.

21. The computer readable medium of claim 19 wherein the portable memory device is accessible by way of a memory slot interface and wherein the operating system further comprises a memory slot interface driver and wherein the operating system causes the processor to recognize a portable memory device by causing the processor to execute the memory slot driver that, when executed by the processor, minimally causes the processor to mount as a disk in a file structure a solid-state medium communicatively coupled to the memory slot interface.

22. The computer readable medium of claim 19 wherein the operating system causes the processor to present a list of identified files by minimally causing the processor to create a graphical image reflecting one or more files stored on a portable memory device communicatively attached to a portable memory device interface and wherein the operating system includes a display driver that, when executed by the processor, minimally causes the processor to convey the graphical image to a display engine.

23. The computer readable medium of claim 19 wherein the user entry device comprises a touch screen and the operating system includes a touch screen driver and wherein the operating system causes the processor to receive a user file selection by minimally causing the processor to execute the touch screen driver that, when executed by the processor, minimally causes the processor to receive a touch event from the touch screen and to establish a user file selection by correlating the touch event with a graphical representation of one or more files names presented on the display device.

24. The computer readable medium of claim 19 wherein the user entry device comprises a user key and the operating system includes a keystroke driver and wherein the operating system causes the processor to receive a user file selection by minimally causing the processor to execute the keystroke driver that, when executed by the processor, minimally causes the processor to receive a keystroke event from the user key and to establish a user file selection by correlating the keystroke event with a graphical representation of one or more files names presented on the display device.

25. The computer readable medium of claim 19 wherein the operating system causes the processor to:
direct a user file selection to the file viewer application as a launch argument so as to cause the file viewer application to open a file according to the launch argument; and
direct the file viewer application to print the opened file.

26. The computer readable medium of claim 25 wherein the file viewer application comprises at least one of a word processing file viewer application, a spreadsheet file viewer application, a presentation file viewing application, and a portable document file viewer application.

27. The computer readable medium of claim 19 wherein the operating system causes the processor to:
direct a user file selection to the file viewer application as a launch argument so as to cause the file viewer application to open and display to a user a file according to the launch argument; and
receive a print directive from a user.

28. A hard-copy output device comprising:
means for reading a portable memory device;
means for generating a list of files stored on the portable memory device;
means for receiving a receiving a file selection from a user;
means for preparing a printable image according to a file opened according to the file selection received from a user; and
means for preparing a hard-copy of the printable image.

29. The hard-copy output device of claim 28 wherein the means for receiving a user file selection comprises:
means for presenting to a user a list of files stored on a portable memory device; and
means for allowing a user to select one or more of the presented files.

30. The hard-copy output device of claim 28 wherein the means for preparing a printable image comprises at least one of a means for viewing a word processing file, a means for viewing a spreadsheet file, a means for viewing a presentation file and a means for viewing a portable document format file.
